(19) United States
(12) Patent Application Publication
(10) Pub. No.: US 2014/0358711 A1
(43) Pub. Date: Dec. 4, 2014

(54) NETWORK-BASED GIFT SERVICE

(71) Applicant: Achor Technologies, Inc., St. Louis, MO (US)

(72) Inventor: Kirk A. Arbogast, Trenton, IL (US)

(73) Assignee: Achor Technologies, Inc., St. Louis, MO (US)

(21) Appl. No.: 14/289,489

(22) Filed: May 28, 2014

Related U.S. Application Data
(60) Provisional application No. 61/828,136, filed on May 28, 2013.

(51) Int. Cl. G06Q 30/06

(52) U.S. Cl. CPC G06Q 30/0601
USPC 705/26.1

(57) ABSTRACT

A web-based service providing a platform for users to manage gift lists for themselves and engage in gift giving to others through other existing web services. The technology communicates and may be embedded within other network services that have a customer base of users such that the existing web services may receive input from users to select and purchase gifts through their existing websites. The technology may also communicate with and be embedded with existing fulfillment web services. A web service manages user accounts, shares content with existing web services, and provides its own social networking platform. Users may access their accounts and utilize the invention web services via the invention web service itself, applications embedded in other web services, and mobile device applications.

### CROSS REFERENCE TO RELATED APPLICATIONS

This application claims the priority benefit of U.S. Provisional Application Ser. No. 61/828,136, titled “Network-Based Gift Service,” filed May 28, 2013, the disclosure of which is incorporated herein by reference.

### BACKGROUND

Some network services allow users to interact with other users. For example, social networking services allow their users to send messages to each other such as ‘Happy Birthday.’ Other network services, such as network services associated with a book store, allow user to shop for merchandise and send the merchandise to a recipient.

Though these services allow for inter-user communication or gift giving, there are disadvantages. Most services provide their own system and corresponding protocols for sending messages. For example, a user on one service cannot interact with a user on another service. Also, services that allow users to set up an account, order merchandise, and send the merchandise to someone else do not have a social component. What is needed is an improved method for providing a gift service.

### SUMMARY

The present technology is a web-based service that provides a platform for users to manage gift lists for themselves and gift giving to others through other existing web services. The invention communicates and may be embedded within existing social networking services, dating web services, hobby web services, and other web services that have a customer base of users such that the existing web services may receive input from users to select and purchase gifts through their existing websites. The invention may also communicate with and be embedded with existing fulfillment web services, such as web-based retail services, web-based auction services and other web-based fulfillment services, to fulfill orders received through that or other web service.

The invention may include a web service that manages user accounts, shares content with existing web services, and provides its own social networking platform. Users may access their accounts and utilize the invention web services via the invention web service itself, applications embedded in other web services, and mobile device applications.

### BRIEF DESCRIPTION OF THE DRAWINGS

FIG. 1 is an illustration of a relationship between a gift service and other web services.

FIG. 2 is a block diagram of an network gift service system.

FIG. 3 is a block diagram of a mobile application.

FIG. 4 is a block diagram of a server application.

FIG. 5 is a block diagram of a gift service module.

FIG. 6A is flow chart of a method for providing a gift service.

FIG. 6B is flow chart of a method for creating a gift list.

FIG. 7 is a block diagram of an exemplary computing device for implementing the present technology.

FIG. 8 is a block diagram of an exemplary mobile device for implementing the present technology.

### DETAILED DESCRIPTION

The present technology is a web-based service that provides a platform for users to manage gift lists for themselves and gift giving to others through other existing web services. The invention communicates and may be embedded within existing social networking services, dating web services, hobby web services, and other web services that have a customer base of users such that the existing web services may receive input from users to select and purchase gifts through their existing websites. The invention may also communicate with and be embedded with existing fulfillment web services, such as web-based retail services, web-based auction services and other web-based fulfillment services, to fulfill orders received through that or other web service. The invention may include a web service that manages user accounts, shares content with existing web services, and provides its own social networking platform. Users may access their accounts and utilize the invention web services via the invention web service itself, applications embedded in other web services, and mobile device applications.

The present technology provides a services framework, providing a single portal for communication with remote applications and other network services. The network service may be supported by an integrated product set, be designed to use a common and standardized navigation framework, operate using and controlled by user profile objects, and use a standard messaging protocol. The service framework reduces or eliminates the need for multiple applications and allows users to customize their personal portal by specifying their portfolio of services.

Gifts may be selected for a user based on at least the user requests, profile, user location, other users, and events. A user may confirm or reject potential gifts selected for the user. By providing a user with a suggested list of gifts, the user saves time in searching for the gifts his or her self.

The present service may provide functionality including but not limited to user authentication, creating a ‘wish box’, associating a wish box to a life event or date, searching for items (e.g., via retail web site advertising APIs), adding an item to a ‘wish box’, sharing lists, see who is viewing one's own list, customizing the look and feel of a list, and printing a customized list. Additional functionality may include commenting and recommending items for a list, viewing who has purchased an item from a list, viewing a confirmation that list items have been purchased, following other people and lists, providing and managing a shopping cart, providing reminders for birthdays, holidays and life events, splitting gifts with other buyers, donating a gift, recommending gifts automatically, receiving item recommendations for receives, trending gifts, preset holidays, asking someone to fill out a list, providing thank you cards, verification of a gift, providing digital goods, providing a card for purchasing gifts on the present network service, gift points, gamification on share, sending cards on someone's birthday, and countdowns to events.

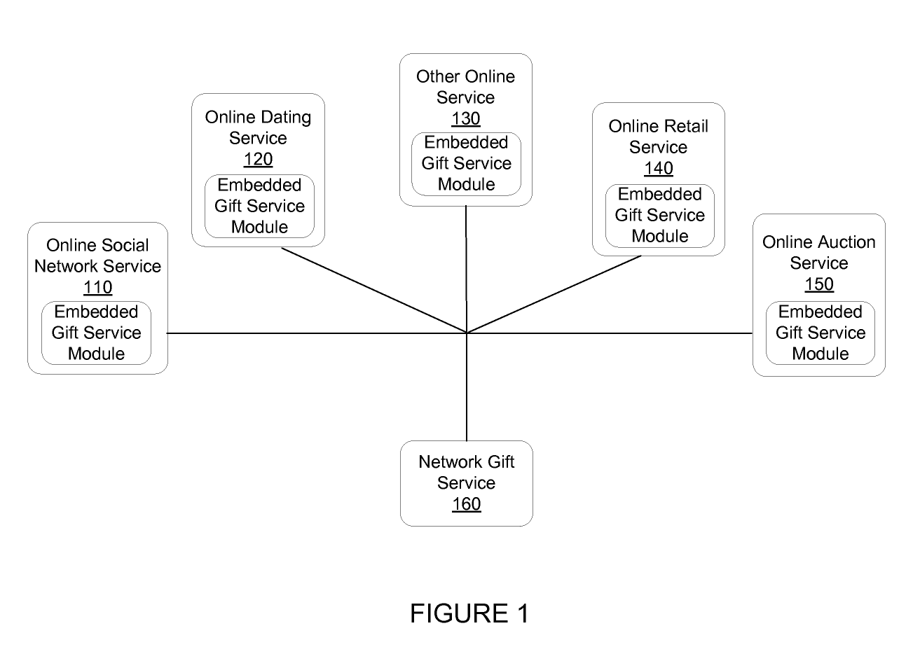

FIG. 1 is an illustration of a relationship between a gift service and other web services. FIG. 1 includes an online social network service 110, online dating service 120, other online service 130, online retail service 140, and online auction service 150. Online social network service 110 and online dating service 120 may allow users of the particular service to communicate with each other. For example, the online social network service 110 may allow each of many users to create a profile, maintain a personal page, connect with other users and communicate with them by writing on their page, and provide other features for communication. An example of an online social network service is “Facebook.” The online dating network service 110 may allow each of many users to create a profile, view information about other users whom they may be interested in dating, and communicate with other users. An example of an online dating network service is “Match.com.”

Online retail service 140 may allow a user to create a profile, browser products available for purchase, advertise products for sale, and to purchase and sell products. An example of an online retail service 140 is “Amazon.com.” Online auction service 140 may allow a user to create a profile, browser products available for auction, provide a product to be auctioned, and participate as a buyer or seller in an auction. An example of an online retail service 140 is “eBay.com.”

Network gift service 160 may provide a network based service for providing and managing gifts and gift lists over pre-existing online services, such as services 110-150. Network gift service 160 may communicate with other online services and allow users associated with each respective online service to manage a gift list and purchase gift for others from their gift list. Users may access gift lists through social, dating, and other online services and purchase the gifts for fulfillment through retail, auction and other online services.

Each online service 110-150 may include an embedded gift service module. The embedded gift service module may allow users of the particular online service at access and manage a wish list for themselves. The embedded gift service module may also allow users to access a wish list for a contact of the user, such as those they have a connection with on the particular online service, and purchase a gift from the contact's wish list. The embedded gift service module may communicate with uses of the particular online service it is embedded in, the network gift service, and a fulfillment service. The embedded modules allow the network gift service to function with user pools of other network services and tie the services to fulfillment centers to complete gift transactions.

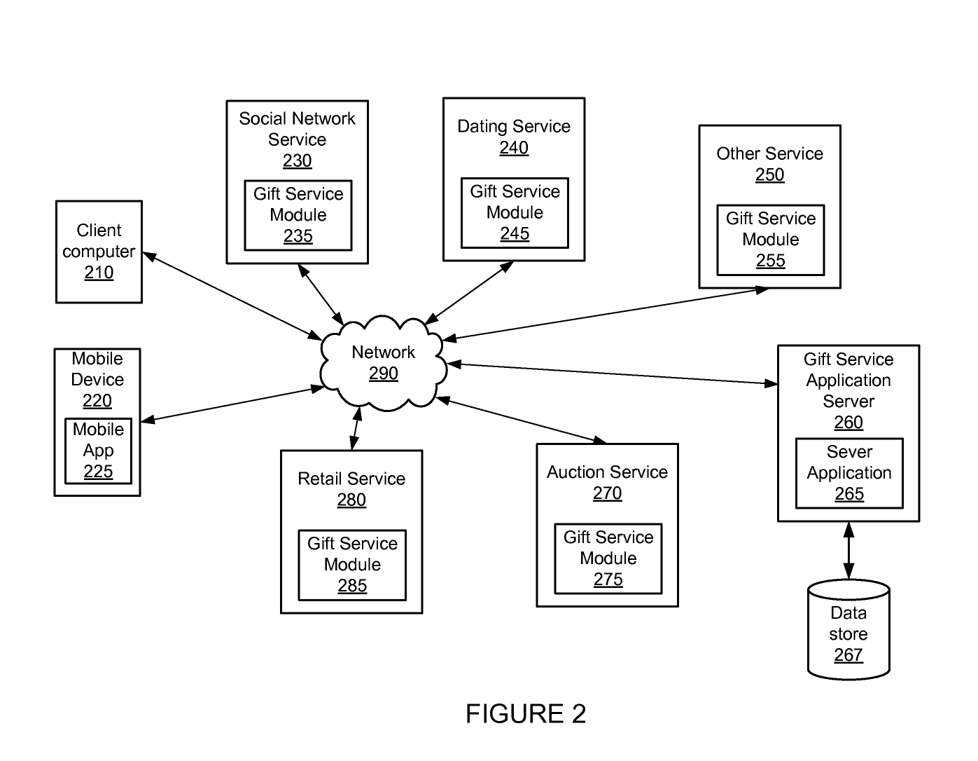

FIG. 2 is a block diagram of a network gift service system. The system of FIG. 2 includes client computer 210, mobile device 220, social network service 230, dating service 240, other service 250, gift service application server 260, auction service 270, retail service 280, and network 290.

Client device 105 may include a computer such as a desk top, workstation, or other computer. The client device may include a network browser (not shown) or other client application for viewing content provided by an application server, such as application server 260 and services 230-250 and 270-280 over network 290.

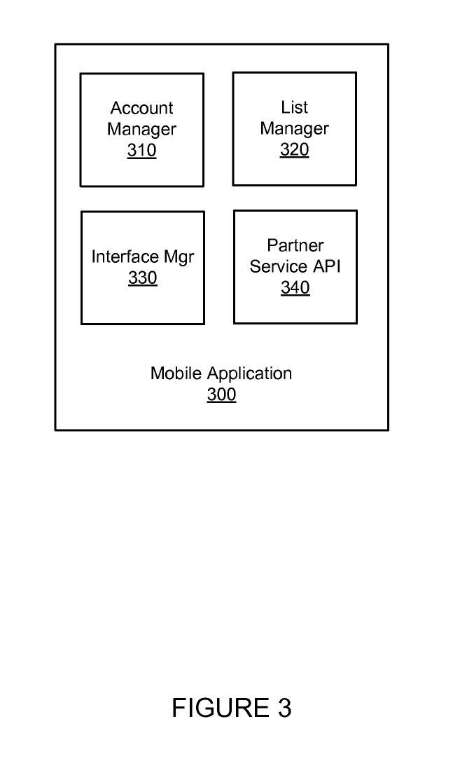

Mobile device 220 is connected to network 120 and may be implemented as a portable device suitable for receiving content over a network, such as for example a mobile phone, smart phone, tablet computer, or other portable device. Both client device 210 and mobile device 220 may include hardware and/or software configured to access a web service provided by application server 280 as well as services 230-250 and 270-280. Mobile device 220 may include mobile application 225 and may provide one or more features associated with the gift service at the mobile device 220. Mobile application 225 is discussed in more detail below with respect to FIG. 3.

Network 120 may facilitate communication of data between different servers, devices and machines. The network may be implemented as a private network, public network, intranet, the Internet, cellular network, Wi-Fi network, or a combination of these networks.

Each of services 230-250 and 270-280 may provide a service similar to online service 110-150 of FIG. 1. Each of services 230-250 and 270-280 may be provided with one or more application servers having one or more applications, network servers that communicate between network 290 and application services, and databases that may be accessed by service application servers and network servers.

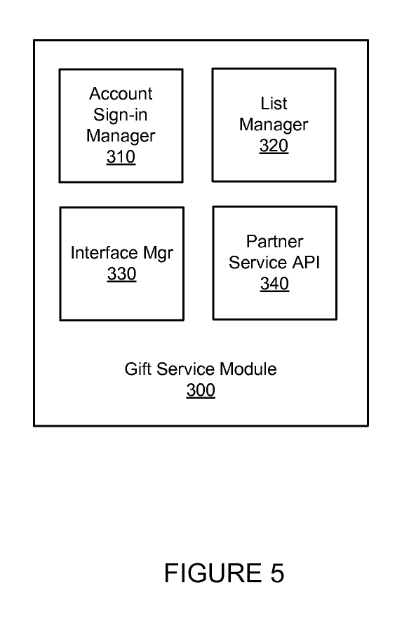

Each of services 230-250 and 270-280 may include a gift service module. The gift service module may be embedded in the particular service, such as for example a program stored on an application server, and may provide one or more features associated with the gift service at the particular service 230-250 and 270-280. A gift service module is discussed in more detail below with respect to FIG. 5.

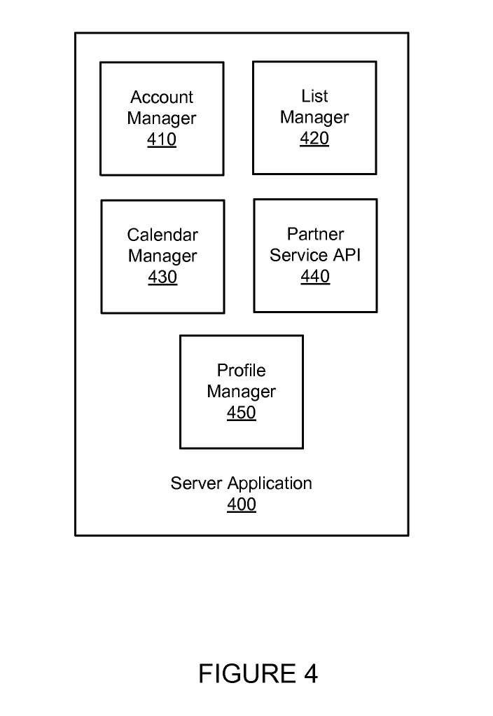

Gift service application server 260 may communicate with data store 267 and 230-250 and 270-280 via network 290. Application server 260 may include server application 265 which may be executed to implement the features of the present technology. Server application 265 is discussed in more detail below with respect to FIG. 4.

Data store 267 may be accessed by application server 265. Data store 267 store and process data used, created and otherwise associated with the service provided by server 260 and server application 265, and return queries received from application server 265.

A user profile for each user of the service provided by server 260 may be stored at data store 267. A user profile may include elements such as for example hobbies, musical preferences, social preferences, geo-spatial data, time data, general interests, personal skills, education, personal traits, professional affiliations, and sports preferences. The content for each element may be tailored to fit the particular user. As such, the service framework may provide a mechanism for development and delivery of products and services that a user desires, when the user wants them and where the user wants them.

Information for particular products and services may also be stored at data store 267. Examples of products and services which may be gifted by a user include but are not limited to information needs, items of interest, social venues, event notifications (based on types, time and spatial considerations), event participation (based on spatial, type and personal skills), people connections, alerts and notifications, professional collaboration, business needs, gifts and products, and sporting venues.

FIG. 3 is a block diagram of a mobile application. Mobile application 300 may include account manager 310, list manager 320, interface manager 330, and partner service API 340. Account manager 310 may enable a user to sign up for the gift service from the mobile application, perform user login, communicate with application server 260 to receive and update user data, and manage user profile information. List manager 320 may enable a user to create and manage the user's gift list and access gift lists of other users. Interface manager 330 may provide interfaces on the mobile device to provide output and receive input from the user, including graphic interfaces, audio, and other device I/O (touch screen, audio, device camera, and so on). Partner service API 340 may manage communications with partner services, such as services 230-250 and 270-280 of FIG. 2. For example, API 340 may communicate using a messaging protocol. The messaging protocol may include attributes such as a contextual header, operational and/or functional state, standardized information structures such as addresses and time, and operation commands.

FIG. 4 is a block diagram of a server application. Server application 400 may include account manager 410, list manager 420, calendar manager 430, partner service API 440, and profile manager 450. Account manager 410 may manage the user's account and provide account data to requesting mobile applications and embedded modules in other services. List manager 420 may manage the user's list and list permissions. Calendar manager 430 may manage the user's dates of interest, such as traditional holidays, professional holidays such as staff appreciation day, anniversaries and other dates that may be associated with gift giving. Partner service API 440 may manage communications with partner services, such as services 230-250 and 270-280 of FIG. 2. For example, API 440 may communicate using a messaging protocol similar to the protocol discussed with respect to API 340. Profile manager 450 may manger the user's profile information and provide the information to requesting mobile applications and embedded modules.

FIG. 5 is block diagram of a gift service module. Gift service module 500 may include account manager 510, list manager 520, interface manager 530, and partner service API 540. Account manager 510 may enable a user to sign up for the gift service from the service in which the module is embedded in, perform user login, communicate with application server 260 to receive and update user data, and manage user profile information. List manager 520 may enable a user to create and manage the user's gift list and access gift lists of other users through the service the module is embedded in. Interface manager 530 may provide interfaces through the service web pages for providing gift service features. Partner service API 540 may manage communications with partner services, such as services 230-250 and 270-280 of FIG. 2. For example, API 540 may communicate using a messaging protocol similar to the protocol discussed with respect to API 340.

The block diagrams of FIGS. 3-5 may include one or more programs or modules that are stored in memory and executed by a processor to perform functionality associated with the present technology. The particular modules illustrated are exemplary, and the scope of the invention is intended to include applications and modules with fewer or more modules as needed.

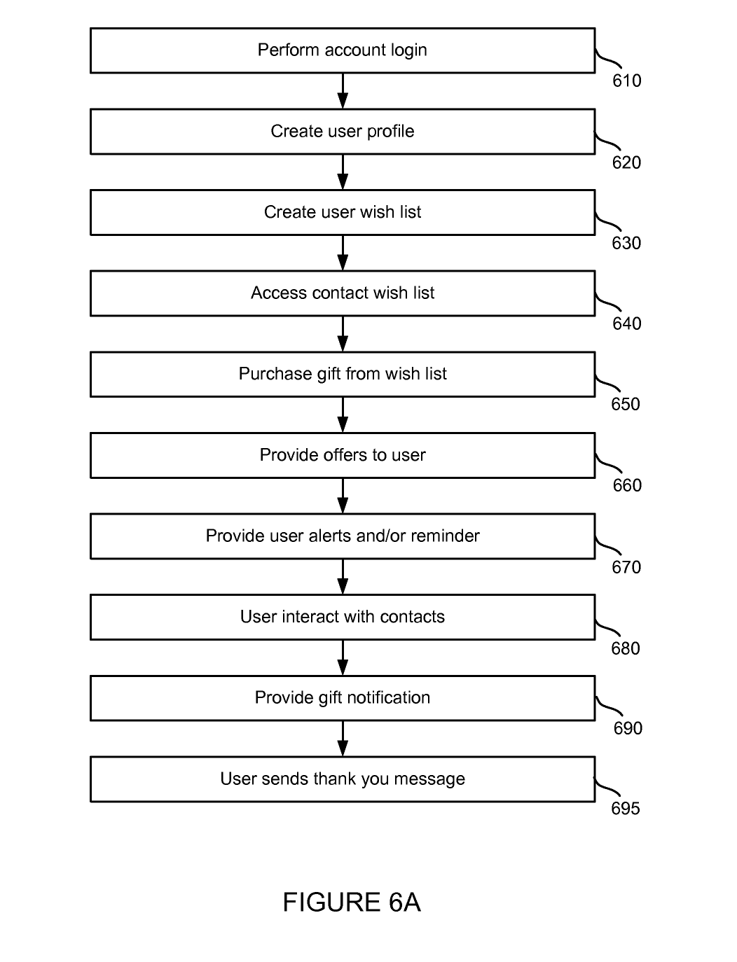

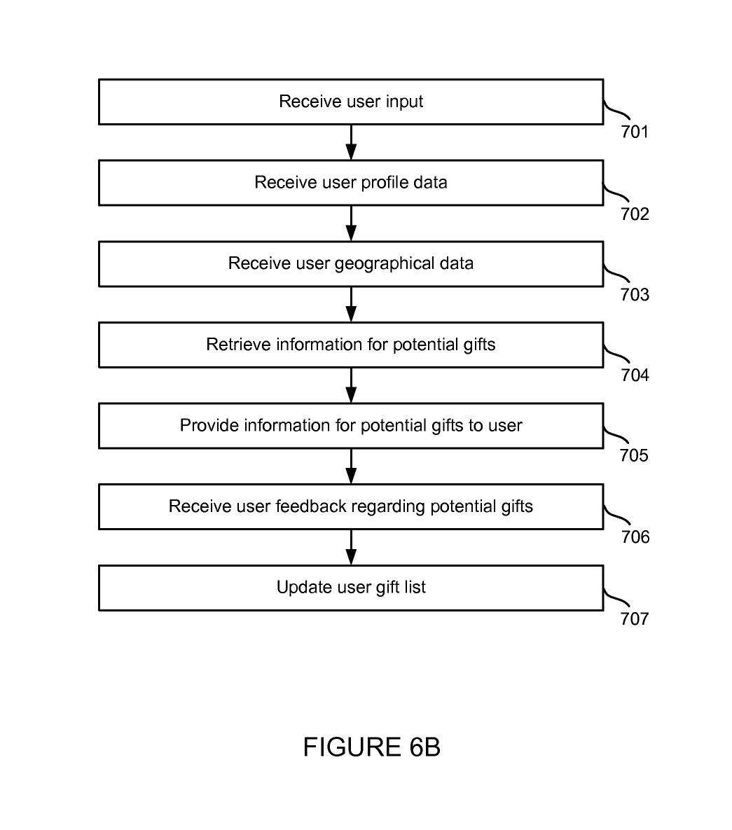

FIG. 6A is flow chart of a method for providing a gift service. The method of claim 6 may be performed by one or more of mobile application 225, application 265, any of gift service modules 235-285, a program such as a network browser on client computer 210, or other portions of the system of FIG. 2. Though the steps of FIG. 6A are listed in a particular order, the order is not intended to be limiting. The steps may be performed in a different order than that shown, and not all steps need be performed during operation of the invention.

First, account login is performed at step 610. Account login may include receiving a user name and password by application 265 and comparing the received information to stored account data. If the user does not have an account, the user may create an account at step 610 by providing user identification and other information.

A user profile may be generated at step 620. The user profile may include user preferences, network services for which the user has an account, and other information. Examples of user profile information includes user hobbies, musical preferences, social preferences, geo-spatial data, time data, general interests, personal skills, education, personal traits, professional affiliations, and sports preferences. User profile information may be received directly from a user, determined based on gifts purchased for the user (by others or the user him or herself), determining the location of the user, and so on. The user profile may be changed at any time.

A user wish list may be created at step 630. The user wish list may be created from websites, brick-and-mortar stores, a user profile, a user's network, and other sources. The user wish list may be stored in association with the user's account and may be changed at any time by the user. More details regarding creating a user wish list are discussed with respect to FIG. 6B.

A user may access a wish list of another user at step 640. The wish list may be accessed for a contact through another service, such as a social networking service or dating service. In some embodiments, the information retrieved from the wish list may be based on a group or sub-group that the user is or is not a member of.

The user may purchase a gift from the wish list at step 650. To purchase a gift from the wish list, the user may provide input to select a particular item on the wish list. In some embodiments, the user may provide input as a request to purchase a gift for another user. The user request may include parameters such as at least one of event data (holiday, birthday, wedding, and so on), item attributes (make, model, color, etc.), time restrictions, pricing data, and geographical location data. The user may then be provided with information for gifts that comply with the request parameters from a fulfillment service. The fulfillment service information may be retrieved by an embedded module within the service the user is currently interacting with. The user may then interact with the fulfillment service to purchase the item from the wish list.

The retrieval of information from the fulfillment service may be performed, for example, using the messaging protocol. The messaging protocol allows for a single portal to provide access to remote applications on mobile devices, application servers, remote network services, and other programs and hardware that wish to communicate with the presently described framework. The messaging protocol includes a contextual header, operational and/or functional state, standardized information structures and operational commands. The standardized messages allow for a well-defined set of methods for each service. When a new service is added, the methods required for the service are known. Once developed, the service is now available to all mobile and web devices. The user will access the new service using the mobile device portal and navigational framework. As such, over time, as the number of services which ‘plug-in’ to the system grows, a user's capabilities will increase without the need to download and learn an ever increasing set of applications.

Offers may be provided to a user at step 660. The offer may be based on sales, price reductions, the user's locale, a time or event, or other data. Alerts and reminders may be provided to a user at step 670. The alerts and reminders may be configured by the user or set to default values. Alerts and reminders may notify a user of an approaching holiday, birthday, or other date that may be suitable for purchasing a gift from a gift list. An alert and/or reminder may also prompt a user to complete the user's profile, rate a product, or perform some other task.

A user may interact with other contacts at step 680. The user may interact with other users within the gift service by chatting, messaging, posting to other user pages and bulletin boards, and other forms of communication.

A gift notification may be provided to a user at step 690. The gift notification may indicate that a gift from the user's wish list has been purchased by someone. A user may send a thank you or other message to a user that purchased a gift from the user's wish list at step 695.

FIG. 6B is flow chart of a method for creating a gift list. User input may be received at step 701. The input may be received from a user via a mobile application, web site provided by the present framework, a partnering network service such as a social network service, or other source. The input may include gift preferences, and other data.

In some instances, the input may be received by presenting an image or other information to the user through a display and allowing the user to accept or reject the assertion, for example via a swipe across the screen towards an accept icon or rejection icon. In this manner, feedback may be provided by the user on product suggestions automatically provided by the present system. Input may also be received by scanning products with a camera to identify actual products a user comes across in person. Input may further be received by scans of products the user has previously purchased. These three forms of input may provide a basis for an algorithm for determining what products the user is interested. The algorithm allows the framework to suggest better (i.e., more tailored) products for addition to the user's list, which can be presented to the user via the “accept or reject” swipe. Input received from the user in each of the three forms may be stored in the user's profile.

User profile data may be received at step 702.

User geographical data may be received at step 703. The geographical data may be received from a mobile device associated with the user, a web service that receives a ‘check-in’ or other geographical data associated with the user, or other source.

Information may be retrieved for potential user gifts at step 704. In some embodiments, the present framework may access the user input, profile data, geographical data, as well as other data such as current events. The accessed data may be used to determine a potential gift for the user. The potential gift may be searched for by a bot, for example a bot configured to search a retail networking service. Once retrieved, information for potential gifts may be stored in a data store. The information may include a gift name, type, uniform resource locator or other location information associated with the gift, item price, an image of the item, and other data.

Information for potential gifts is provided to a user at step 705. The information may include a list of gifts for the user as well as potential or suggested gifts, such as those determined at step 704. User feedback regarding the potential gifts is received at step 706. In some embodiments, a user may provide input to confirm or reject potential or suggested gifts. For example, a user may ‘swipe’ an icon, image or other information displayed in a touch screen and related to a gift in a first direction if he wishes to keep the gift on his list or swipe in a second direction if he wishes to reject the potential or suggested gift.

The user's gift list is then updated based on the retrieved potential gift information and user input at step 707. The gift list may be updated at data store 267. The updated gift list may be provided, using the messaging protocol described herein, to a user upon request, other users requesting to view the user's gift list, other network services, and so on.

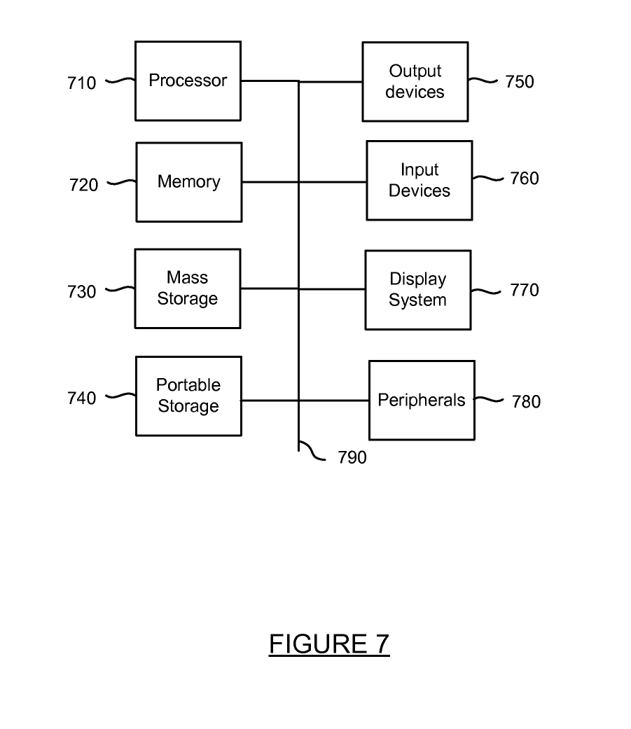

FIG. 7 illustrates an exemplary computing system 700 that may be used to implement a computing device for use with the present technology. System 700 of FIG. 7 may be implemented in the contexts of the likes of client computer 210, servers that comprise services 230-250 and 270-280, application server 260, and data store 267. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

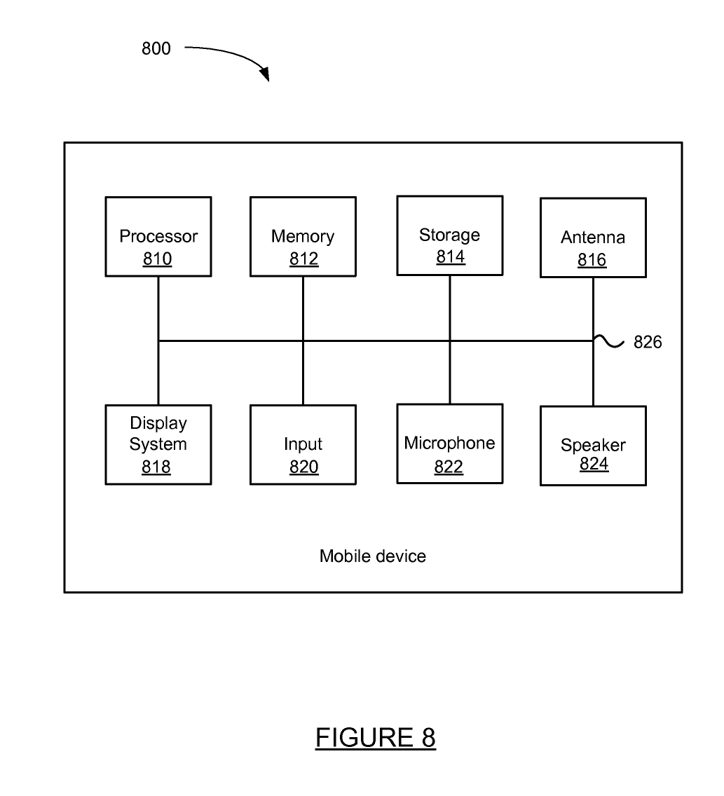

FIG. 8 illustrates an exemplary mobile device system 800 that may be used to implement a mobile device for use with the present technology, such as for mobile device 220. The mobile device 800 of FIG. 8 includes one or more processors 810 and memory 812. Memory 812 stores, in part, programs, instructions and data for execution and processing by processor 810. The system 800 of FIG. 8 further includes storage 814, one or more antennas 816, a display system 818, inputs 820, one or more microphones 822, and one or more speakers 824.

The components shown in FIG. 8 are depicted as being connected via a single bus 826. However, the components 810-824 may be connected through one or more data transport means. For example, processor unit 810 and main memory 812 may be connected via a local microprocessor bus, and storage 814, display system 818, input 820, and microphone 822 and speaker 824 may be connected via one or more input/output (I/O) buses.

Memory 812 may include local memory such as RAM and ROM, portable memory in the form of an insertable memory card or other attachment (e.g., via universal serial bus), a magnetic disk drive or an optical disk drive, a form of FLASH or PROM memory, or other electronic storage medium. Memory 812 can store the system software for implementing embodiments of the present invention for purposes of loading that software into main memory 810.

Antenna 816 may include one or more antennas for communicating wirelessly with another device. Antenna 816 may be used, for example, to communicate wirelessly via Wi-Fi, Bluetooth, with a cellular network, or with other wireless protocols and systems. The one or more antennas may be controlled by a processor 810, which may include a controller, to transmit and receive wireless signals. For example, processor 810 execute programs stored in memory 812 to control antenna 816 transmit a wireless signal to a cellular network and receive a wireless signal from a cellular network.

Display system 818 may include a liquid crystal display (LCD), a touch screen display, or other suitable display device. Display system 818 may be controlled to display textual and graphical information and output to text and graphics through a display device. When implemented with a touch screen display, the display system may receive input and transmit the input to processor 810 and memory 812.

Input devices 820 provide a portion of a user interface. Input devices 820 may include an alpha-numeric keypad, such as a keyboard, for inputting alpha-numeric and other information, a touch-screen, microphone, camera, buttons or switches, a trackball, stylus, or cursor direction keys.

Microphone 822 may include one or more microphone devices which transmit captured acoustic signals to processor 810 and memory 812. The acoustic signals may be processed to transmit over a network via antenna 816.

Speaker 824 may provide an audio output for mobile device 800. For example, a signal received at antenna 816 may be processed by a program stored in memory 812 and executed by processor 810. The output of the executed program may be provided to speaker 824 which provides audio. Additionally, processor 810 may generate an audio signal, for example an audible alert, and output the audible alert through speaker 824.

The mobile device system 800 as shown in FIG. 8 may include devices and components in addition to those illustrated in FIG. 8. For example, mobile device system 800 may include an additional network interface such as a universal serial bus (USB) port.

The components contained in the computer system 800 of FIG. 8 are those typically found in mobile device systems that may be suitable for use with embodiments of the present invention and are intended to represent a broad category of such mobile device components that are well known in the art. Thus, the computer system 800 of FIG. 8 can be a cellular phone, smart phone, hand held computing device, minicomputer, or any other computing device. The mobile device can also include different bus configurations, networked platforms, multi-processor platforms, etc. Various operating systems can be used including Unix, Linux, Windows, Macintosh OS, Google OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for providing a network gift service, comprising:
receiving a request from a first user to purchase a gift for a second user by a gift module embedded in a first network service;
providing an interface associated with a second network service for purchasing the gift by the gift module; and
updating gift data for the second user based on the purchased gift.

2. The method of claim 1, wherein the request includes at least one of event data, item attributes, time restrictions, pricing data, and geographical location data.

3. The method of claim 2, further comprising retrieving information for a gift based on at least one of the event data, item attributes, time restrictions, pricing data, and geographical location data.

4. The method of claim 3, further comprising providing a network location for at least one of the gifts.

5. The method of claim 1, wherein updating the gift data includes updating whether the gift has been purchased.

6. The method of claim 1, further comprising searching for matching items requested by multiple users to be located simultaneously

7. The method of claim 1, further comprising creating a gift list for the second user based on the second user's profile.

8. The method of claim 1, wherein the gift list is created based on the second user's geographical data.

9. The method of claim 1, wherein the first user provides the request from a mobile device, the mobile device and one or more servers implementing the second network service in communication with the first network service using the same messaging protocol.

10. The method of claim 1, further comprising providing the first user with a list of one or more gifts for the second user, the list generated at least in part from products scanned by the second user, products purchased by the second user, and feedback from the second user on automatically provided product suggestions.

11. The method of claim 1, further comprising receiving feedback from the second user regarding a suggested gift, the feedback consisting of a swiping input received on a touch screen to communicate acceptance or rejection of the suggested gift.

12. A non-transitory computer readable storage medium having embodied thereon a program, the program being executable by a processor to perform a method for providing a network gift service, the method comprising:
receiving a request from a first user to purchase a gift for a second user by a gift module embedded in a first network service;
providing an interface associated with a second network service for purchasing the gift by the gift module; and
updating gift data for the second user based on the purchased gift.

13. The non-transitory computer readable storage medium of claim 12, wherein the request includes at least one of event data, item attributes, time restrictions, pricing data, and geographical location data.

14. The non-transitory computer readable storage medium of claim 13, the method further comprising retrieving information for a gift based on at least one of the event data, item attributes, time restrictions, pricing data, and geographical location data.

15. The non-transitory computer readable storage medium of claim 14, the method further comprising providing a network location for at least one of the gifts.

16. The non-transitory computer readable storage medium of claim 12, wherein updating the gift data includes updating whether the gift has been purchased.

17. The non-transitory computer readable storage medium of claim 12, the method further comprising searching for matching items requested by multiple users to be located simultaneously

18. The non-transitory computer readable storage medium of claim 12, the method further comprising creating a gift list for the second user based on the second user's profile.

19. The non-transitory computer readable storage medium of claim 12, wherein the gift list is created based on the second user's geographical data.

20. The non-transitory computer readable storage medium of claim 12, wherein the first user provides the request from a mobile device, the mobile device and one or more servers implementing the second network service in communication with the first network service using the same messaging protocol.

21. A system for providing a network gift service, comprising:
a processor;
memory; and
two or more modules stored in memory and executable by the processor to receive a request from a first user to purchase a gift for a second user by a gift module embedded in a first network service, provide an interface associated with a second network service for purchasing the gift by the gift module, and update gift data for the second user based on the purchased gift.

22. The system of claim 21, wherein the request includes at least one of event data, item attributes, time restrictions, pricing data, and geographical location data.

23. The system of claim 22, further comprising retrieving information for a gift based on at least one of the event data, item attributes, time restrictions, pricing data, and geographical location data.

24. The system of claim 23, further comprising providing a network location for at least one of the gifts.

25. The system of claim 21, wherein updating the gift data includes updating whether the gift has been purchased.

26. The system of claim 21, further comprising searching for matching items requested by multiple users to be located simultaneously

27. The system of claim 21, further comprising creating a gift list for the second user based on the second user's profile.

28. The system of claim 21, wherein the gift list is created based on the second user's geographical data.

29. The system of claim 21, wherein the first user provides the request from a mobile device, the mobile device and one or more servers implementing the second network service in communication with the first network service using the same messaging protocol.
